(19) United States
(12) Patent Application Publication
(10) Pub. No.: US 2005/0276392 A1
(43) Pub. Date: Dec. 15, 2005

(54) Videophone station and method for videophone link

(76) Inventor: Marc Berenguer, Revel (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/521,713

(22) PCT Filed: Jul. 16, 2003
(86) PCT No.: PCT/FR03/02241

§ 371 Date: Jan. 19, 2005

(30) Foreign Application Priority Data
Jul. 19, 2002 (FR) 02/09206

(51) Int. Cl. H04M 11/00

(52) U.S. Cl. 379/88.13

(57) ABSTRACT

A videophone station is provided. The videophone station includes a digital processing unit operative to receive a distant person image and data relative to the distant person, a generally vertical first screen operative to display the data relative to the distant person or a distant person image received by the digital processing unit, a means of capturing an image of the local person, and a second screen arranged at a foot of the first screen and oriented on an inclined plane with respect to the horizontal between the first screen and the local person for displaying the data relative to the distant person when the first screen displays the distant person image. A videophone system and method are also provided for facilitating conversation between a local person and a distant person via a telecommunication network.

The field of the invention is that of workstations adapted for inter-person conversation.

Such workstations are encountered in call centers where locally to a workstation, it is the job of an expert to assist distant persons who are hooked up with him via a telecommunication network. Known for example are telephone call centers to which one turns in order to solve a computing problem or to request details of various facilities.

Generally, a workstation comprises means of oral telecommunication such as a telephone often fitted with a headset and with a microphone so as to leave the expert's hands free since he may need to consult documents in order to respond to problems that are submitted to him by each distant person with which he is hooked up. Such a hands free system allows the expert to handle the documents without interrupting the conversation with the other party.

These documents are for example paper documents such as a medical dossier if the other party is a patient, a contractual dossier if the other party is a subscriber, a catalogue of articles of a company if the other party is a potential customer. A table then allows the expert to arrange the paper documents in front of him so as to consult them during the conversation that he is conducting with the other party.

These documents are for example furthermore electronic documents stored in a database. A digital processing unit such as a microcomputer, then allows the expert to display information on a screen facing him, so as to assist the other party. Such computing systems facilitate fast access to pertinent information and reduce the potential physical bulkiness of paper documents.

The workstations of the prior art which relate to call centers are satisfactory as long as a strong human relationship is not paramount. A relationship by phone link, or even written with electronic messages, is sufficient to obtain details about a service or a product, without even needing to actually know the expert who is responding.

However, these workstations do not afford full satisfaction when a more complete human relationship forms part of the response to be provided. The attitude of the expert has for example a physiological influence on the confidence that the other party accords to the response provided within the framework of a commercial negotiation or advice. To take another example, moreover within the framework of a home medical consultation by conversation with the expert from the call center, the patient is often in as much need of being comforted by being sure of the presence of a human person who will attend to him as of actions, care or diagnosis, undertaken remotely. Conversely, an expert negotiator or carer, needs to analyze the behavior or the state of the customer or patient with whom he is dealing.

Real-time presentation of the face of the distant person to the expert or of the expert to the distant person would be useful in the conversation for adding to the intonations of the voice, physiological features such as skin complexion, and the expression of the mouth or eyes.

A display of the face of the distant person in a window of the screen of the workstation which serves to display knowledge necessary for the responses of the expert, introduces the drawback of reducing the useful area of the screen for displaying this knowledge. This poses a problem especially when a great deal of cognitive information is necessary. A reduction in the size of the window is not a satisfactory solution since it might generate difficulties in distinguishing the features and assessing the facial expressions of the distant person. A large-size window decreases the ability to display cognitive information. Compensating for these losses of cognitive information through recourse to paper documents loses the benefit afforded by a digital database.

An aim of the invention is to be able to respond by videophone to a caller while also consulting documents such as dossiers or documentation, to be able to offer an image of an agent, the so-called local person, to a caller, the so-called distant person, in order to promote conversation throughout the communication, to be able to hold a session of several hours of service without having physical problems due to work posture.

In order to respond to the aims and needs alluded to above, a first subject of the invention is a videophone station for conversation between a first so-called local person and at least one second so-called distant person via a telecommunication network, the videophone station comprising means of oral telecommunication. The workstation is noteworthy in that it comprises:
a digital processing unit designed to receive at least one distant person image and data of conversation with said distant person,
a first screen arranged facing said local person, designed to display at least one distant person image received by the digital processing unit,
means of capture of an image of said local person, that are arranged in such a way as to minimize a first angle between a picture taking axis of the means of capture and a viewing axis of the first screen,
a second screen arranged at the foot of the first screen on an inclined plane which separates the first screen from said local person, designed to display all or some of the data received by the digital processing unit,
control means arranged between the second screen and said local person, and designed to drive the digital processing unit.

The screens may be of cathode ray tube type. In order to increase the room available and fine-tune the ergonomics of the videophone, the first and the second screens are flat screens.

Especially, the image capture means comprise a camera having its own network address and designed to send video frames over the telecommunication network.

Advantageously, the control means comprise a mouse and/or a joystick and the digital processing unit is designed to steer a distant camera as a function of commands received from the mouse or from the joystick.

Advantageously again, the digital processing unit is connected to a local area network to which are connected other similar videophone stations.

Advantageously also, the digital processing unit is connected to a telephone link of ADSL or ISDN type.

More especially, the first screen is designed to also display information relating to an environment of conversation with at least one distant person.

More especially also, the control means comprise a keyboard and the digital processing unit is designed to record data entered by the local person with the aid of the keyboard.

More especially still, a first axis perpendicular to the plane of the first screen makes an angle of 30° with the local person's viewing axis and the second screen is integrated into a work table so that the inclined plane which supports it makes an angle of 40° with the horizontal.

Advantageously, the camera is arranged above or below, and touching the first screen.

A second subject of the invention is a videophone method for conversation between a first so-called local person and at least one second so-called distant person via a telecommunication network. The method is noteworthy in that it comprises:
a first permanent step consisting in capturing an image of the local person and in displaying telecommunication information on a first screen arranged facing said local person,
a second step consisting in establishing a telephone link between the local person and the distant person selected by means of the telecommunication information,
a third step consisting in displaying on a second screen arranged on an inclined plane between the first screen and the local person, data received by a digital processing unit.

Advantageously the videophone method includes:
a fourth step consisting in displaying on the first screen an interface for driving a camera situated facing the distant person,
a fifth step consisting in displaying on the first screen, an image of the distant person captured by said camera.

The invention will be better understood with the aid of the description of an implementation which follows with reference to the appended drawings, in which:

FIG. 1 is a diagram of a known workstation;

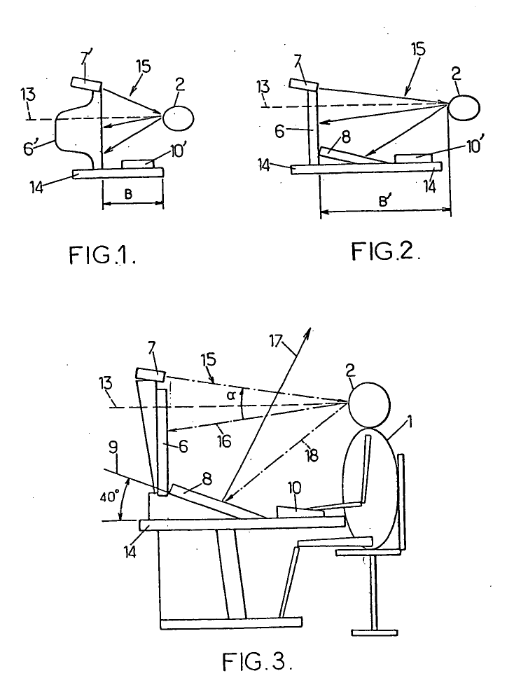

FIG. 2 is a diagram of a workstation in accordance with the invention;

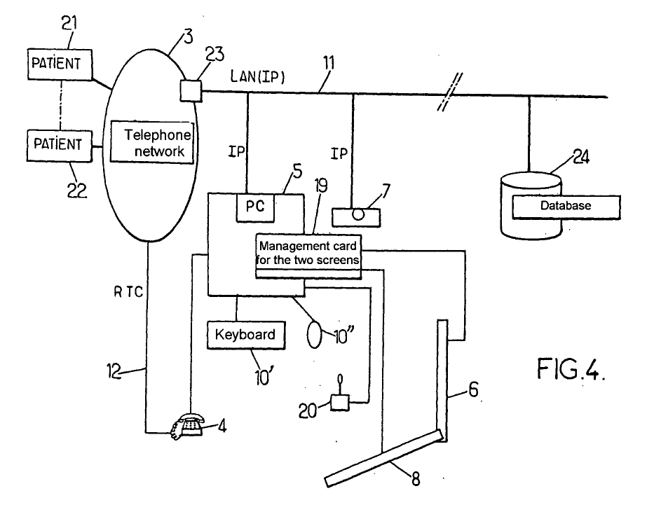

FIG. 3 is a more detailed diagram of a workstation in accordance with the invention;

FIG. 4 is a diagram of a networked workstation architecture;

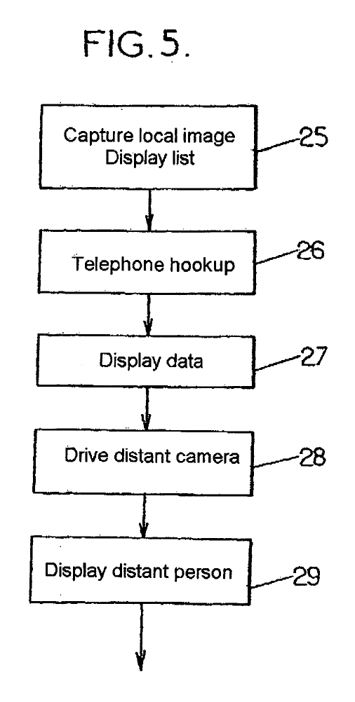

FIG. 5 is a method step flowchart in accordance with the invention.

With reference to FIG. 1, microcomputer-based video conferencing systems for example are known in which a local person's face 2 is directed toward a screen 6′ above which a camera 7′ linked to an input/output port of the microcomputer captures an image of the face 2.

The screen 6′ is arranged substantially vertically on a work plane 14′. A keyboard 10′ and possibly a mouse (not represented here) are generally arranged on the work plane 14′, in proximity to the screen 6′. The screen 6′ represented here is of cathode ray tube type. The front surface of the screen 6′ is a distance B from an end of the work plane where the local person is situated.

The camera 7′ serves to transmit an image of the face 2 to a distant person who is situated in front of a piece of equipment similar to that described here. The camera takes a picture along an axis 15 which goes from the objective of the camera 7′ to the face 2. The gaze of the local person looks along a viewing axis 13 which goes from the face 2 to the screen 6′ along a substantially horizontal direction. On account of the relatively short distance B, a non-negligible angle of offset between the axis 15 and the axis 13 has the effect of the camera 7′ capturing an image of the face 2 which gives a sensation of lowering the eyes instead of looking straight at the distant person. This effect is amplified when the face 2 looks toward the parts of the screen that are located under the axis 13.

A window displayed on the screen 6′ makes it possible to depict a distant person's face. This window is generally of relatively restricted size so as to make it possible to display useful information, for example on the topic of the video conference or faces of other conference participants. On such workstations, one is often content with a restricted size since the image definition of the camera 7′ is relatively poor so as to facilitate the throughput over a network.

However, this type of workstation poses a problem of information concentration within a confined space. Specifically, the overload of useful information on the screen may be detrimental to the reading of the information, induce postural constraints on the local person and eventually be detrimental to the service rendered to the other party.

FIG. 2 is a diagram of a workstation in accordance with the invention. The videophone station represented here is more especially adapted to a call center dedicated to assisting persons at home. It is therefore important to get a good idea of the condition of the patient by virtue of videophone information and to be able to respond in the most relevant way with the help of the information medium available. The juxtaposition of these two sources of information must be as easy to understand as possible.

The local person's face 2 is directed toward a flat screen 6 of plasma or liquid crystal type. Whereas conventional cathode ray tube screens have drawbacks of bulkiness, heat dissipation and radiation, flat screens allow flexibility in the possibilities of arrangement.

The screen 6 is designed to display an image of a distant person such as a patient and some general information about the environment of the service of the call center, such as information pertaining to a queue of incoming calls, a patient to be called, an alarm, a name of a distant person in conversation or the like. The image of the distant person is preferably full screen together with the general information at the edge or overlaid.

A screen 8 is arranged at the foot of the screen 6 on a plane that is slightly inclined with respect to the horizontal. The screen 8 is designed to display information that the local person needs in order to respond. This information relates to the distant person, such as for example in respect of a patient, his pathological condition, his history of care, his contractual and social conditions or relates to documentation, such as for example medical knowledge. At the foot of the screen 8 arranged on the work plane 14 is arranged the keyboard 10′.

A camera 7 is arranged against the screen 6 at the top thereof or interposed between its foot and the top of the screen 8. The camera 7 is designed to capture a moving image of the face 2 in real time.

This arrangement of the screens 6 and 8 makes it possible to remotely recreate a framework similar to that of a normal consultation where the practitioner consults his dossier, often in paper form, at his disposal on his desk at the same time as he is looking at the patient opposite him. Within the framework of a consultation at home or in a surgery, the patient physically faces the practitioner who looks back and forth between the paper dossier and the patient during a questioning phase.

This arrangement of the screens 6 and 8 plus the arrangement of the keyboard 10′ also has a more directly technical effect. A distance B′ which separates the face 2 from the screen 6 with the camera 7 is larger than the distance B represented in FIG. 1. This increase in distance results from the size of the screen 8 interposed nearly prone on the work plane 14 between the screen 6 and the keyboard 10′. This increase in distance considerably reduces the angle of offset between the axes 13 and 15. The distant person is thus rather more of the impression that the local person is looking straight at him. More especially if the camera 7 is arranged between the screen 6 and the screen 8, the gaze of the local person invariably crosses that of the distant person when the local person goes from the screen 6 to the screen 8 and vice versa. The camera 7 together with its optical objective is therefore sufficiently miniaturized to allow its insertion between the screens 6 and 8.

The reduction in the angle of offset brings improvements in comfort to the distant person who is less of the impression that the local person is looking at his feet. The reduction in the angle of offset also brings improvements of comfort to the local person who is not compelled to lift his head to look at the camera and thus relieves the stresses on the back of his neck, eventually a source of physical problems.

FIG. 3 is a more detailed diagram of a workstation in accordance with the invention. On the inclined plane 9, the screen 8 passes at its lower end into the work plane 14 so that the two screens 6 and 8 can be lowered together. Hence, an axis 16 of viewing of the videophone screen 6 makes an angle of 30° with the local person's sighting axis 13. The control means 10 are arranged on the work plane 14 so that the arm and the forearm of the local person make an angle of 90°, the recommended position for avoiding fatigue.

The increase in distance between the screen 6 and the local person which results from the arrangement of the screen 8 and of the control means 10 between the screen 6 and the local person, minimizes an angle α between the picture taking axis 15 and the viewing axis 16, so long as the capture means 7 are located at the top rather than at the base of the screen 6.

The plane of a screen is generally defined by an ordinate axis going from bottom to top of the screen and an abscissa axis going from left to right of the screen. In a plane perpendicular to that of the screen defined by an axis 17 normal to the screen and an axis 18 of viewing of the screen, manufacturers of screens generally advise against exceeding an angle of 120° between the ordinate axis and the axis 18 and an angle of 90° between the abscissa axis and the axis 18 so as to retain good visibility of the screen. The inclined plane 9 contains the ordinate axis of the screen 8 along its greatest slope. The inclined plane 8 has an inclination of substantially 40° with respect to the work plane 14 so that the angle between the ordinate axis and the axis 18 is less than 120° at every point of the screen, in particular at the top of the screen 8. Depending on the technological characteristics of the screens 6 and 8, the contrast and brightness setting of the screen 8 is adjusted to a value greater than that of the screen 6.

The relative arrangement of the screen 8 with respect to the screen 6 allows the local person to access a great deal of information on the screen 8 without making large movements of his head and thus without increasing fatigue at the end of a session.

The light around the workstation is controlled so that the image of the local person, also dubbed the operator, is constant during a session. The light is controlled so as not to reflect on the screens in order to avoid any nuisance to the operator. The color of the screens may have an impact on the color of the operator's face since the luminance of flat screens throws illumination onto same. If the background of the screen is predominantly red, the image of the face that is captured by the camera 7 has a ruddy complexion whereas if it is predominantly blue, the image of the face that is captured by the camera 7 has a rather more pallid complexion. A very light blue is recommended so as not to render the operator's face too pale and not to overly distort the color of the skin.

FIG. 4 is a diagram of a networked workstation architecture.

A microcomputer 5 is connected to a local area network 11 (LAN). The control means 10 comprise a keyboard 10′, a mouse 10″ and a joystick 20 that are plugged into the microcomputer 5. The microcomputer 5 comprises a card 19 for managing several screens, into which the screens 6 and 8 are plugged. The card 19 inserted into the microcomputer 5 is designed to drive the two screens separately while ensuring continuity of the commands from one to the other so that the mouse 10″ can be used to navigate from one screen to the other without a break in operation. The connection of the microcomputer 5 to the local area network 11 is especially appropriate in respect of a multistation call center. Since the microcomputer 5 possesses its own IP address, it behaves as an internet type server.

In the case of an isolated workstation, a connection of the microcomputer 5 to a telephone line of ADSL or ISDN type is suitable.

The speech part of the communication can pass through a telephone network 12 of STN type, independently of the local area network 11. A telephone 4 linked on the one hand to the network 12 allows the local person to communicate in a simple manner by voice with a distant person. The telephone 4 linked on the other hand to the microcomputer 5 makes it possible to effect an association between the telephone number of the distant person and computer data relating to this distant person.

The camera 7 here possesses its own IP address so as to be connected to the local area network 11. The camera 7 behaves likewise as an Internet type server. When it is queried with a request, the camera 7 dispatches IP frames of images in JPEG format, in bursts of between 15 and 25 images per second over the local area network 11.

The local area network 11 is attached to a wide area network 3 by a gateway 23. When the wide area network 3 is of Internet type, the gateway 23 is of proxy server type. When the wide area network 3 is of telephone type, the gateway 23 is of access point type with a special call number as in the case of internet access providers.

One or more customer stations 21, 22, each allocated to a patient may connect up to the gateway 23 via the wide area network 3. Each customer station 21, 22, is equipped with a camera, not represented, which can be driven via the joystick 20 from the microcomputer 5.

In order to provide a service video part, a customer station 21 is equipped with a screen, not represented, designed to receive the images from the camera 7. The microcomputer 5 is designed to display the images from the camera of the customer station 21 on the screen 6. The speech part is provided by the conventional STN type telephone network by means of a modem card installed in the microcomputer 5.

A database server 24 is connected to the local area network 11 so as to be able to be interrogated from the microcomputer 5 by means of the keyboard 10′ and or of the mouse 10″ so as to display information on the screen 8. At the level of the call center represented in FIG. 4 there is a coupling between the presentation of the telephone number and an identifier of the patient. The card 19 with which the microcomputer 5 is equipped makes it possible to distribute the information onto one or other of the screens 6 or 8.

The system just described makes it possible to implement the method described below with reference to FIG. 5.

Within the more particular framework of home assistance to so-called frail persons, the local person of the call center is dubbed the tele-assistant, the distant person is dubbed the patient.

In a step 25, the microcomputer 5 displays on the screen 6 information which relates to the call center. In step 25, the camera 7 captures an image of the tele-assistant in real time so as to be ready at any moment to dispatch this moving image over the local area network 11.

When a patient calls, his name is displayed in a list. A step 26 is triggered when the tele-assistant clicks with the mouse 10″ on a patient's name chosen from the list. The communication is initially set up by speech. In step 26, the microcomputer 5 automatically interrogates the data server 24 to display on the screen 6 information relating to the patient. The information which was displayed in step 25 is reduced so that it remains only in the form of a banner in which the previously detailed information is indexed by numerals. During this speech phase of communication, the tele-assistant has menus at his disposal on the screen 6 which allow him to interrogate the database server 24 so as to choose to display on the screen 6 general information relating to the patient who is communicating, such as his marital status, his type of contract, his general pathological condition, the history of all the previous calls and a summary for each of these calls. A template allows the tele-assistant to write comments about the current communication using the keyboard 10′. The tele-assistant can bring up the details of the patient dossier on the screen 8.

Depending on the nature of the call, the communication may remain in speech mode to the end. If the tele-assistant deems it useful, he switches over to videophone by issuing a command via the keyboard 10′ or the mouse 10″ so as to trigger a step 27.

In step 27, the microcomputer 5 displays the patient-specific information on the screen 8, leaving in the background of the screen 6 only certain general information relating to the call center and patient-related particulars such as his name.

In a step 29, the microcomputer 5 displays on the screen 6 an image of the patient that was received via the local area network 11 from the distant camera with which the customer station 21, 22 of the patient is equipped at home.

In a step 28, the microcomputer 5 also displays on the screen 6 computing tools for remotely driving the home camera, for example by means of the joystick 20 for performing zooms or rotations of the home camera. Simultaneously, the microcomputer 5 dispatches the IP address of the camera 7 to the customer station 21, 22 so that the customer station can display a real-time image of the tele-assistant on his home screen. The comments template is available on the screen 8 throughout the communication. A telemetry template may also appear on the screen 8 for displaying data from apparatus sensors for monitoring the patient at home.

At the end of the communication, the tele-assistant has a certain amount of time to finish writing his comments and to close the assignment. The microcomputer 5 then automatically stores in the patient dossier managed by the database server 24, all the information gathered during the communication, comments, photos, data. The screens then resume their configuration of step 25.

1. A videophone station for conversation between a local person and a distant person via a telecommunication network having a means of oral telecommunication, the videophone station comprising:
a digital processing unit operative to receive at least one of a distant person image and data relative to said distant person;
a generally vertical first screen operative to display at least the distant person image received by the digital processing unit;
means of capturing an image of said local person, said means being arranged relative to the first screen to minimize a first angle between a picture taking axis of the means and a viewing axis of the first screen;
a second screen arranged at a foot of the first screen and oriented on an inclined plane, the second screen disposed between the first screen and said local person for displaying the data relative to said distant person; and
control means disposed between the second screen and said local person, and operative to drive the digital processing unit.

2. The videophone station as claimed in claim 1, wherein the first and second screens comprise flat screens.

3. The videophone station as claimed in claim 1, wherein the image capture means comprises a camera having a unique network address, the camera operative to send video frames over the telecommunication network.

4. The videophone station as claimed in claim 1, wherein the control means comprises at least one of a mouse and a joystick linked with the digital processing unit, the digital processing unit being operable to steer a camera proximate said distant person in response to commands received from at least one of the mouse and the joystick.

5. The videophone station as claimed in claim 1, wherein the digital processing unit is connected to a local area network including at least one other videophone station.

6. The videophone station as claimed in claim 1, wherein the digital processing unit is connected to a telephone link being at least one of a ADSL and ISDN type.

7. The videophone station as claimed in claim 1, wherein the first screen is operative to also display information relating to an environment of said distant person.

8. The videophone station as claimed in claim 1, wherein the control means comprises a keyboard and the digital processing unit being operable to record data entered by the local person via the keyboard.

9. The videophone station as claimed in claim 1, further comprising a work table that orients the first and second screens so that a first viewing axis for viewing the first screen makes an angle of approximately 30° with respect to a horizontal plane and the second screen is oriented at an angle of approximately 40° with the horizontal plane.

10. The videophone station as claimed in claim 3, wherein the camera is disposed proximate the first screen and at least one of immediately above and below the first screen.

11. A method for conversation between a local person and a distant person via a videophone station connected to a telecommunication network and including a camera and first and second screens, the method comprising the steps of:
capturing an image of the local person with the camera;
displaying telecommunication information on the first screen that is oriented to be facing said local person;
establishing an audio link between the local person and the distant person relative to the displayed telecommunication information;
displaying on a first screen data relative to the distant person received by a digital processing unit; and
determining if video communication between the local person and the distant person should be initiated.

12. The method of claim 11 further comprising the steps of:
establishing a video communication link between the local person and the distant person;
transferring the data relative to the distant person from the first screen to the second screen which is oriented between the first screen and the local person; and
displaying an image on the first screen of the distant person that is captured by a distant camera that is proximate to and facing the distant person.

13. The method of claim 12 further comprising the step of displaying on at least one of the first and second screens an interface for driving the distant camera.

14. The method of claim 12 further comprising the step of displaying a telemetry template on at least one of the first and second screens for monitoring sensor data relative to the distant person.

15. The method of claim 11 further comprising the step of interrogating a data server based on the telecommunication information to receive information relating to the distant person, the data server in communication with the videophone station.

16. A videophone system comprising:
a local area network including a gateway that attaches the local area network to a wide area network;
a videophone connected to the local area network and a telephone network, the videophone including a microcomputer, a first camera having a first network address, a generally vertical first screen linked to the first microcomputer, an inclined second screen linked to the first microcomputer and disposed at a foot of the first screen, and a control means linked with the first microcomputer; and
a remote station connected to at least one of the telephone network and the wide area network, the remote station including a screen for displaying an image captured by the first camera, and a second camera having a second network address and driveable by the control means.

17. The videophone system of claim 16 further comprising a database server connected to the local area network, the database server storing information relative to a user of the remote station for retrieval by the first microcomputer.

18. The videophone system of claim 16 wherein the control means comprises at least one of a keyboard, a joystick and a mouse.

19. The videophone system of claim 16 wherein the remote station further comprises a second control means for driving the first camera.

20. The videophone system of claim 16 wherein the wide area network comprises at least one of the Internet and the public switched telephone network.
